(19) United States
(12) Patent Application Publication
(10) Pub. No.: US 2017/0146988 A1
(43) Pub. Date: May 25, 2017

(54) OPERATION MONITORING DEVICE FOR MONITORING OPERATIONS OF MACHINING DEVICES IN MACHINING LINE

(71) Applicant: FANUC Corporation, Yamanashi (JP)

(72) Inventor: Satoshi HASEGAWA, Yamanashi (JP)

(21) Appl. No.: 15/342,600

(22) Filed: Nov. 3, 2016

(30) Foreign Application Priority Data
Nov. 25, 2015 (JP) 2015-229342

(51) Int. Cl. G05B 23/02; G06Q 50/28

(52) U.S. Cl. CPC G05B 23/0221; G06Q 50/28; G05B 2219/31319

(57) ABSTRACT

An operation monitoring device monitors operations of machining devices in a machining line. Information on a workpiece stocker that constitutes the machining line is acquired, and a current workpiece stock number for the workpiece stocker is updated based on the acquired information. The necessity of change of machining speeds of the machining devices constituting the machining line is determined based on the current stock number for the workpiece stocker. Based on the result of the determination, change of the machining speeds is commanded to the machining devices located before and behind the workpiece stocker in the machining line.

### BACKGROUND OF THE INVENTION

Field of the Invention

The present invention relates to an operation monitoring device for monitoring operations of machining devices in a machining line.

Description of the Related Art

In a production system for machine parts, the machine parts are produced by a machining line that automatically performs a series of operations in which a plurality of machining devices receive and machine workpieces and deliver them to the next machining process. In some cases, the machining line of this type comprising the machining devices may be provided with workpiece stockers arranged between the machining devices and configured to temporarily store machined workpieces (e.g., Japanese Patent Application Laid-Open No. 4-141350). In FIG. 5, reference symbols 3a, 3b, 3c and 3d denote first, second, third, and fourth machining devices, respectively, reference symbols 4a, 4b and 4c denote first, second, and third workpiece stockers, respectively, and reference symbols 5a, 5b and 5c denote first, second and third workpieces, respectively.

Even if any machining device is temporarily stopped due to maintenance work or failure, for example, the use of the workpiece stockers that function as buffers can ensure smooth operation of the machining line.

If there is a certain or greater difference in machining man-hour between machining processes, however, some of the machining devices are eventually stopped to wait for the supply or delivery of the workpieces from or to the workpiece stockers as the machining line is operated. If the machining devices constituting the machining line are thus stopped to wait for the supply or delivery of the workpieces, a problem occurs that a large number of in-process goods stagnate in the workpiece stockers, and consequently, excess stock of in-process goods may reduce the business income.

### SUMMARY OF THE INVENTION

Accordingly, the object of the present invention is to provide an operation monitoring device for monitoring operations of machining devices in a machining line, configured to perform monitoring so that an excessive amount of in-process goods do not stagnate in workpiece stockers that constitute the machining line.

In an operation monitoring device according to the present invention, the number of workpieces stocked in a workpiece stocker is monitored and acceleration or deceleration commands are issued to machining devices in pre- and post-processes for the workpiece stocker.

An operation monitoring device for monitoring operations of machining devices in a machining line according to the present invention is configured to monitor the operations of the machining devices in the machining line, comprising the machining devices and at least one workpiece stocker configured to temporarily store workpieces machined by the machining devices, and comprises a workpiece stocker management information storage unit configured to store a current stock number indicative of the number of workpieces currently stocked in each workpiece stocker, an operation information acquisition unit configured to acquire information on a state of the workpiece stocker constituting the machining line, a stock number updating unit configured to update the current stock number for the workpiece stocker stored in the workpiece stocker management information storage unit, based on the information on the state of the workpiece stocker acquired by the operation information acquisition unit, a stock number determination unit configured to determine the necessity of change of machining speeds of the machining devices constituting the machining line, based on the current stock number for the workpiece stocker stored in the workpiece stocker management information storage unit, and a machining speed change command unit configured to command the machining devices located before the workpiece stocker in the machining line and/or the machining devices located behind the workpiece stocker to change the machining speeds thereof if the stock number determination unit determines that the change of the machining speeds is necessary.

The information on the state of the workpiece stocker may include information on workpiece loading from the workpiece stocker located before the machining devices in the machining line and information on workpiece unloading into the workpiece stocker located behind the machining devices in the machining line.

The information on the state of the workpiece stocker may include information detected by a sensor installed on the workpiece stocker.

The workpiece stocker management information storage unit may further store an upper-limit stock number and a lower-limit stock number, and the stock number determination unit may be configured to determine that the change of the machining speeds is necessary for the machining devices located before the workpiece stocker in the machining line and/or the machining devices located behind the workpiece stocker if the workpiece stocker management information storage unit is stored with a workpiece stocker with the current stock number more than the upper-limit stock number or less than the lower-limit stock number.

The workpiece stocker management information storage unit may further store a rate of change, an upper-limit change rate, and a lower-limit change rate of the stock number for each workpiece stocker, and the stock number determination unit may be configured to determine that the change of the machining speeds is necessary for the machining devices located before the workpiece stocker in the machining line and/or the machining devices located behind the workpiece stocker if the workpiece stocker management information storage unit is stored with a workpiece stocker with the stock number change rate higher than the upper-limit change rate or lower than the lower-limit change rate.

According to the present invention, there can be provided an operation monitoring device for monitoring operations of machining devices in a machining line, designed so that acceleration and deceleration commands are issued to the machining devices in pre- and post-processes so as not to unduly increase the number of workpieces in workpiece stockers, thereby preventing a large number of in-process goods from stagnating.

### BRIEF DESCRIPTION OF THE DRAWINGS

The above and other objects and features of the present invention will be obvious from the ensuing description of embodiments with reference to the accompanying drawings, in which:

FIG. 1 is a schematic configuration diagram of an operation monitoring device according to one embodiment of the present invention;

FIG. 2 is a functional block diagram of the operation monitoring device of FIG. 1 that manages a machining line comprising a plurality of machining devices and a plurality of workpiece stockers;

FIG. 3 is a flowchart showing processing performed on the operation monitoring device of FIG. 1;

FIG. 4 is a diagram showing a machining line using an automated warehouse in place of the workpiece stockers of FIG. 2; and

FIG. 5 is a diagram showing a prior art machining line with workpiece stockers.

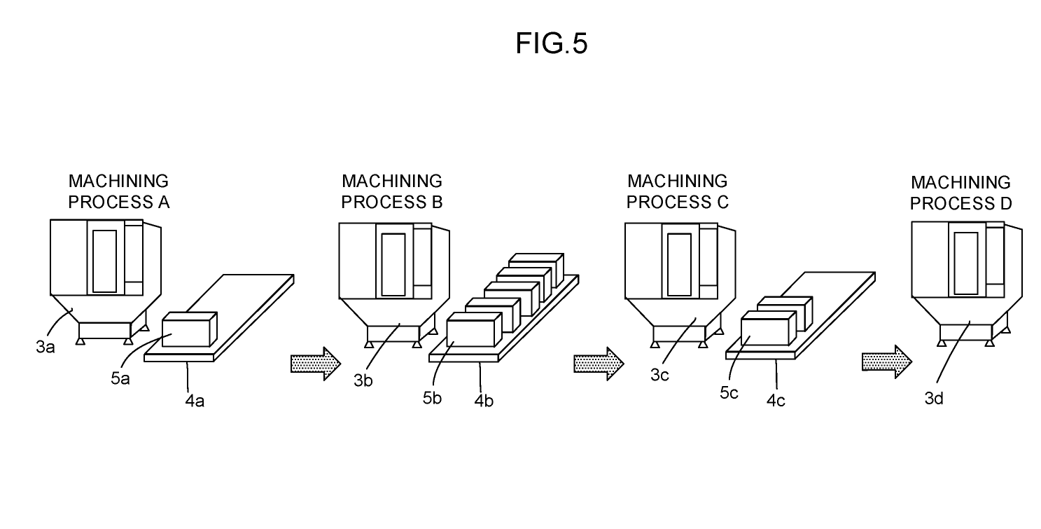

### DETAILED DESCRIPTION OF THE PREFERRED EMBODIMENTS

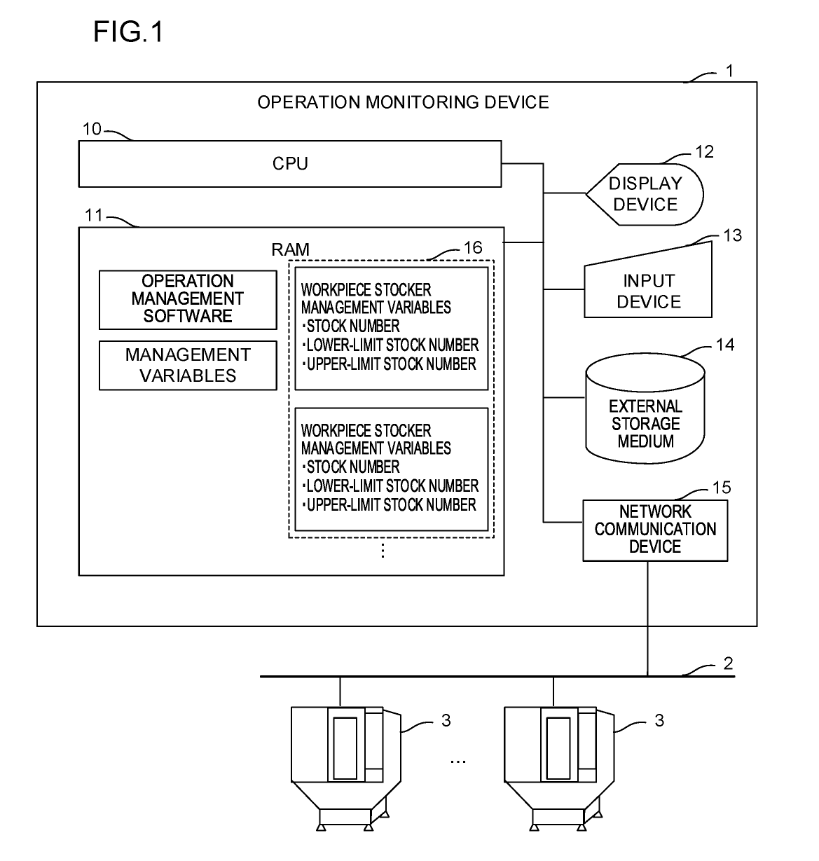

An outline of an operation monitoring device according to one embodiment of the present invention will be described with reference to FIG. 1.

An operation monitoring device 1 comprises a CPU 10, RAM 11, display device 12, input device 13, external storage medium 14, and network communication device 15. The CPU 10 controls the overall operation of the operation monitoring device 1. The RAM 11 stores software for providing functions of the operation monitoring device 1 and various data required for operation. The display device 12 displays the operating conditions of the operation monitoring device 1, the result of processing by the operation, and the like. The input device 13 accepts input from an operator. The external storage medium 14 is used to read and write the necessary software and various data for the operation of the operation monitoring device. The network communication device 15 serves to transmit and receive data to and from a host computer (not shown) and a plurality of machining devices 3 that constitute a machining line through a network 2.

The RAM 11 is stored with operation management software for providing various functions related to operation management by the operation monitoring device 1. The various functions for the operation management are provided as the CPU 10 executes this operation management software. Moreover, the RAM 11 is provided with variables for management for the storage of data used in the functions for the operation management. These variables for management include variables for the storage of network identification information of the machining devices constituting the machining line to be managed in operation, identification information of workpiece stockers, machining line information stored with the workpiece loading/unloading relationships (temporal relationships between machining processes) between the workpiece stockers and the machining devices constituting the machining line, and variables stored with information on the current machining speeds of the machining devices. These data acquired and generated in processing related to the operation management are stored and updated and, if necessary, read out. Furthermore, the RAM 11 is provided with variables for management for the individual workpiece stockers, whereby the current number of stocks (number of workpieces stocked in each workpiece stocker) and the lower-limit and upper-limit stock numbers are individually stored and managed at least for each workpiece stocker.

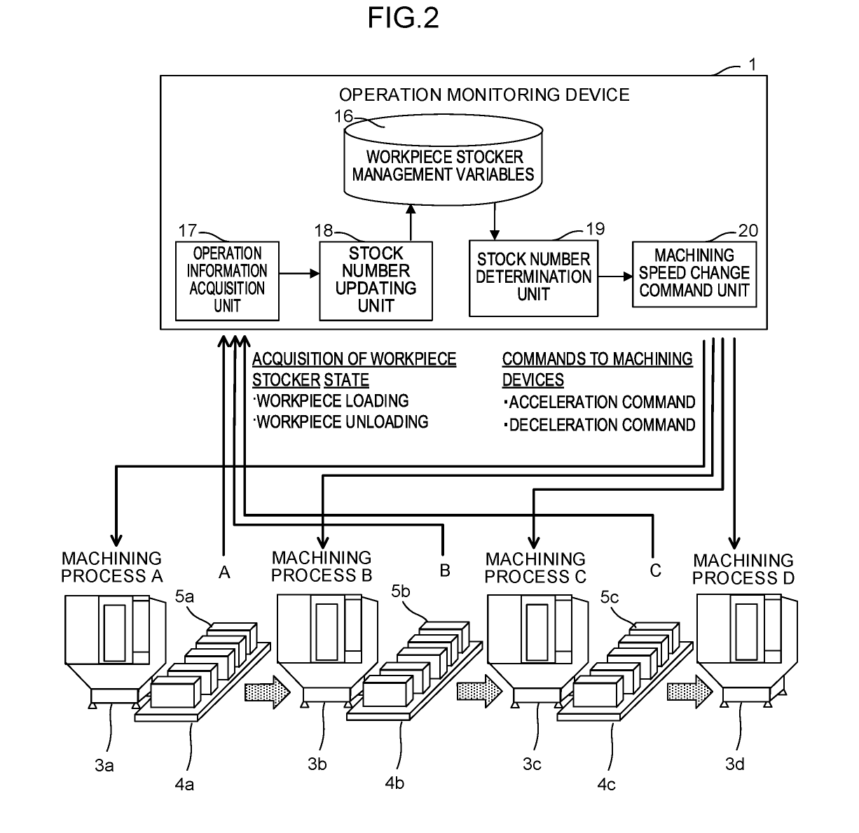

FIG. 2 shows the operation monitoring device 1 that manages the machining line comprising the machining devices 3 (first, second, third, and fourth machining devices 3a, 3b, 3c and 3d) and workpiece stockers 4 (first, second, and third workpiece stockers 4a, 4b and 4c) disposed individually between the machining devices 3.

The machining devices 3 load workpieces 5 (first, second, and third workpieces 5a, 5b and 5c), which are machined in an immediately preceding machining process according to the configuration of the machining line, from the workpiece stockers 4 in the immediately preceding machining process and machine the workpieces 5. Then, the machining devices 3 unload the machined workpieces 5 into the workpiece stockers 4. In FIG. 2, for example, the second machining device 3b loads the first workpiece 5a, which is machined by the first machining device 3a in the immediately preceding machining process and unloaded into the first workpiece stocker 4a, from the first workpiece stocker 4a and machines the first workpiece 5a. Thereafter, the machined workpiece 5b is unloaded into the workpiece stocker 4b.

The machining devices 3 transmit workpiece loading information, which indicates the workpiece stocker 4 from which the workpiece 5 to be machined is loaded, and workpiece unloading information, which indicates the workpiece stocker 4 into which the machined workpiece 5 is unloaded, to the operation monitoring device 1 through the network 2 as the workpieces 5 are loaded and unloaded.

Each of the machining devices 3 is provided with a function capable of changing its machining speed. Changing of an override value is an example of the function of changing the machining speed. Each axis of each machining device 3 moves at a speed obtained by multiplying a commanded speed by the override value, so that the machining speed of the axis can be changed by only changing the override value. In the example of the present embodiment, the machining speed is designed to be changeable in multiple steps such that the override value is increased by 10% by one-step acceleration and reduced by 10% by one-step deceleration, based on a standard override value (100%).

On the other hand, when the operation management software stored in the RAM 11 is executed by the CPU 10 of the operation monitoring device 1, storage areas for the variables for management and workpiece stocker management variables 16 are secured on the RAM 11 by the operation of the CPU 10 based on the operation management software. At the same time, the operation monitoring device 1 operates as a combination of an operation information acquisition unit 17, stock number updating unit 18, stock number determination unit 19, and machining speed change command unit 20.

At the start of execution of the operation management software, the operator may set various pieces of information stored in the variables for management, including the network identification information of the machining devices 3 constituting the machining line to be managed in operation, identification information of the workpiece stockers 4, and machining line information stored with the workpiece loading/unloading relationships (temporal relationships between the machining processes) between the workpiece stockers 4 and the machining devices 3 constituting the machining line, by operating the input device 13 while watching the display device 12 or may read the previously set data from the external storage medium 14 and set them. For the various pieces of information stored in the variables for management, such as the information on the current machining speeds of the machining devices 3, moreover, the operator may acquire step values of the current machining speeds from the machining devices 3 through the network 2.

At the start of execution of the operation management software, furthermore, the current stock number (number of workpieces stocked in each workpiece stocker) stored in the storage area of the workpiece stocker management variables 16 is cleared to 0. For the values of the minimum and maximum stock numbers, information manually set by the operator or previously set information is read from the external storage medium 14 and set.

The operation information acquisition unit 17 acquires the workpiece loading information and the workpiece unloading information output from each machining device 3 through the network.

The stock number updating unit 18 updates the current stock number for each workpiece stocker stored in the storage area of the workpiece stocker management variable 16, based on the workpiece loading information and the workpiece unloading information output from each machining device 3 and acquired by the operation information acquisition unit 17. If the operation information acquisition unit 17 acquires workpiece loading information that indicates that the first workpiece 5a is loaded from the first workpiece stocker 4a by the second machining device 3b, as in FIG. 2, for example, the stock number updating unit 18 reduces the stock number for the first workpiece stocker 4a by 1. If the operation information acquisition unit 17 acquires workpiece unloading information that indicates that the second workpiece 5b is unloaded into the second workpiece stocker 4b by the second machining device 3b, in contrast, the stock number updating unit 18 increases the stock number for the second workpiece stocker 4b by 1.

The stock number determination unit 19 determines whether or not the current stock number for each workpiece stocker 4 is less than a lower-limit stock number or whether or not the current stock number is more than an upper-limit stock number, with reference to the workpiece stocker management variables 16.

The machining speed change command unit 20 outputs change commands for the machining speeds of the machining devices 3 (first, second, third, and fourth machining devices 3a, 3b, 3c and 3d), based on the result of the determination by the stock number determination unit 19. If it is determined by the stock number determination unit 19 that the current stock number for a certain workpiece stocker 4 is less than the lower-limit stock number, a command is issued to the machining device 3 (machining device 3 in the immediately preceding machining process) that is unloading the workpiece 5 into the workpiece stocker 4 to increase its machining speed, as an example of the machining speed change command. At the same time, a command is issued to the machining device 3 (machining device 3 in the immediately succeeding machining process) that is loading the workpiece 5 from the workpiece stocker 4 to reduce its machining speed.

Moreover, if it is determined by the stock number determination unit 19 that the current stock number for a certain workpiece stocker 4 is more than the upper-limit stock number, for example, a command is issued to the machining device 3 (machining device 3 in the immediately preceding machining process) that is unloading the workpiece 5 into the workpiece stocker 4 to reduce its machining speed. At the same time, a command is issued to the machining device 3 (machining device 3 in the immediately succeeding machining process) that is loading the workpiece 5 from the workpiece stocker 4 to increase its machining speed.

Alternatively, the machining speed change command unit 20 may be configured to command the machining device 3 with its machining speed set to the minimum value to suspend machining in commanding the machining device 3 to reduce the machining speed. Furthermore, the machining speed change command unit 20 may be configured, in commanding the machining device 3 with its machining speed set to the maximum value to further increase the machining speed, to command the machining device 3 in the immediately preceding machining process to further reduce its machining speed instead.

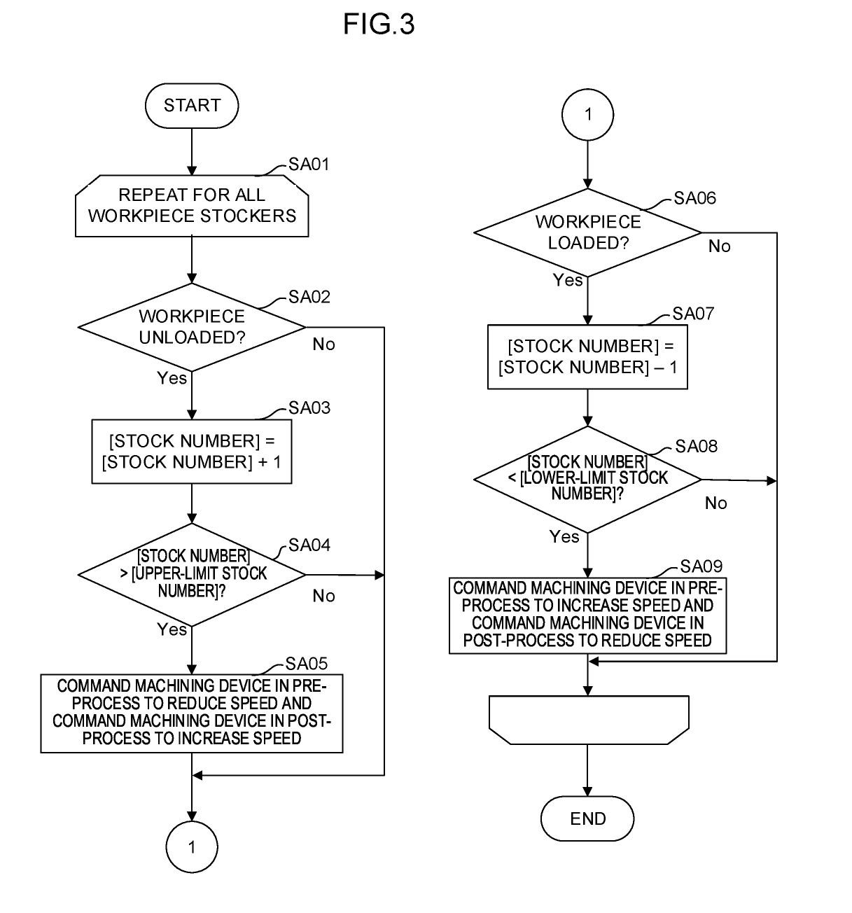

FIG. 3 is a flowchart showing an operation of the operation monitoring device 1 according to the present embodiment.

[Step SA01] The following processing of Steps SA02 to SA09 is repeated for all the workpiece stockers 4 that constitute the machining line to be managed in operation.

[Step SA02] The stock number updating unit 18 determines whether or not the workpiece unloading information that indicates that the workpiece 5 is unloaded from the machining device into the workpiece stocker 4 to be processed is acquired by the operation information acquisition unit 17. If such workpiece unloading information is acquired, the processing proceeds to Step SA03. If not, the processing proceeds to Step SA06.

[Step SA03] The stock number updating unit 18 increases the stock number stored in the storage area of the workpiece stocker management variables 16 of the workpiece stocker 4 to be processed by 1.

[Step SA04] The stock number determination unit 19 determines whether or not the stock number stored in the storage area of the workpiece stocker management variables 16 of the workpiece stocker 4 to be processed is more than the upper-limit stock number. If the stored stock number is more than the upper-limit stock number, the processing proceeds to Step SA05. If not, the processing proceeds to Step SA06.

[Step SA05] The machining speed change command unit 20 commands the machining device 3 (machining device 3 in the immediately preceding machining process) that is unloading the workpiece 5 into the workpiece stocker 4 to be processed to reduce its machining speed, and at the same time, commands the machining device 3 (machining device 3 in the immediately succeeding machining process) that is loading the workpiece 5 from the workpiece stocker 4 to increase its machining speed.

[Step SA06] The stock number updating unit 18 determines whether or not the workpiece loading information that indicates that the workpiece 5 is loaded from the machining device into the workpiece stocker 4 to be processed is acquired by the operation information acquisition unit 17. If such information is acquired, the processing proceeds to Step SA07. If not, the processing in this loop ends.

[Step SA07] The stock number updating unit 18 reduces the stock number stored in the storage area of the workpiece stocker management variables 16 of the workpiece stocker 4 to be processed by 1.

[Step SA08] The stock number determination unit 19 determines whether or not the stock number stored in the storage area of the workpiece stocker management variables 16 of the workpiece stocker 4 to be processed is less than the lower-limit stock number. If the stored stock number is less than the lower-limit stock number, the processing proceeds to Step SA09. If not, the processing in this loop ends.

[Step SA09] The machining speed change command unit 20 commands the machining device 3 (machining device 3 in the immediately preceding machining process) that is unloading the workpiece 5 into the workpiece stocker 4 to be processed to increase its machining speed, and at the same time, commands the machining device 3 (machining device 3 in the immediately succeeding machining process) that is loading the workpiece 5 from the workpiece stocker 4 to reduce its machining speed, whereupon the processing in this loop ends.

While an embodiment of the present invention has been described herein, the invention is not limited to the above-described embodiment and may be suitably modified and embodied in various forms.

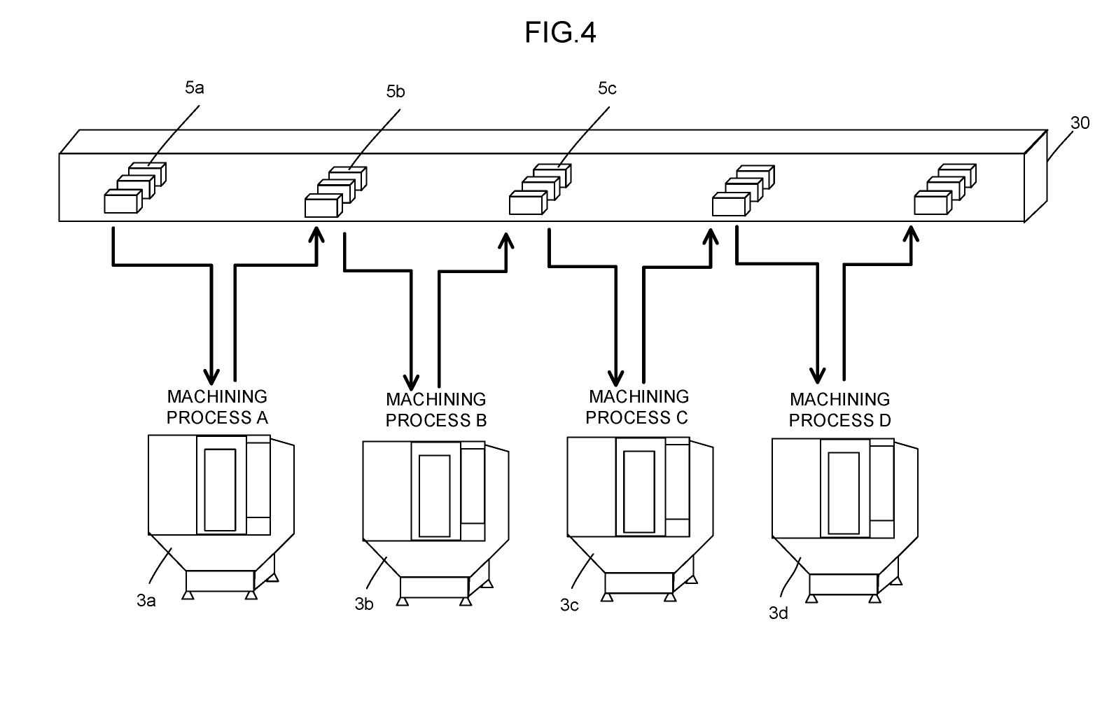

In connection with the above-described embodiment, the operation of the operation monitoring device 1 has been described based on the machining line as an example such that the workpiece stockers 4 are arranged between the machining devices 3. As shown in FIG. 4, however, the operation monitoring device 1 of the present invention can also be applied to a machining line using an automated warehouse 30 as a workpiece stocker with the full effect of the present invention.

Moreover, in the embodiment described above, the change of the machining speed is commanded to both the machining device 3 in the immediately preceding machining process and the machining device 3 in the immediately succeeding machining process. Alternatively, however, the change of the machining speed may be commanded to only one of the machining devices 3 in the immediately preceding and succeeding machining processes.

Furthermore, the change of the machining speed may be commanded to each machining device 3 in comprehensive view of the stock numbers of the workpieces 5 in the plurality of workpiece stockers 4. In the above-described embodiment, if the stock number for the second workpiece stocker 4b exceeds the upper limit, as in FIG. 2, for example, the machining speeds of the third and second machining device 3c and 3b are simply increased and reduced, respectively. Alternatively, however, comprehensive determination may be performed in the following manner, based on the identification of the respective stock numbers for the first workpiece stocker 4a just before the second machining device 3b and the third workpiece stocker 4c just behind the third machining device 3c. Specifically, for example, if the stock number for the third workpiece stocker 4c is close to the upper limit or if the stock number for the first workpiece stocker 4a is close to the lower limit, the machining speed of the second machining device 3b is reduced by two steps without increasing the machining speed of the third machining device 3c, and the machining speed of the first machining device 3a in the process immediately preceding the second machining device 3b is also reduced by one step. Thus, in-process goods can be more flexibly prevented from stagnating by comprehensively controlling the machining speeds of the machining devices 3 before or behind a specific workpiece stocker 4, as well as those of the machining devices 3 just before and behind the specific workpiece stocker 4, depending on the state of the workpiece stocker 4.

Moreover, the variables for workpiece stocker management may be configured to be stored with a combination of the rate of change (amount of change per unit time) of the workpiece stock number calculated based on workpiece loading/unloading information and upper- and lower-limit change rates so that the change of the machining speed can be commanded to each machining device 3 if the change rate of the workpiece stock number for each workpiece stocker 4 exceeds or falls below a preset threshold (i.e., if the stock number suddenly increases or decreases).

In the embodiment described above, furthermore, the stock number for each workpiece stocker 4 is managed by acquiring, from the machining device 3, information on the workpiece unloading into the workpiece stocker 4 and information on the workpiece loading from the workpiece stocker 4. Alternatively, however, each workpiece stocker 4 may be furnished with various sensors, such as a visual sensor, weight sensor, and touch sensor, so that the stock number of the workpieces stored in the workpiece stocker 4 can be acquired from those sensors. In this case, each machining device 3 may be configured to acquire a detected value as a signal from each sensor and transmit each acquired sensor value to the operation monitoring device 1 through the network 2.

1. An operation monitoring device which monitors operations of a plurality of machining devices in a machining line comprising the machining devices and at least one workpiece stocker configured to temporarily store workpieces machined by the machining devices, the operation monitoring device comprising:
a workpiece stocker management information storage unit configured to store a current stock number indicative of the number of workpieces currently stocked in each workpiece stocker;
an operation information acquisition unit configured to acquire information on a state of the workpiece stocker constituting the machining line;
a stock number updating unit configured to update the current stock number for the workpiece stocker stored in the workpiece stocker management information storage unit, based on the information on the state of the workpiece stocker acquired by the operation information acquisition unit;
a stock number determination unit configured to determine the necessity of change of machining speeds of the machining devices constituting the machining line, based on the current stock number for the workpiece stocker stored in the workpiece stocker management information storage unit; and
a machining speed change command unit configured to command the machining devices located before the workpiece stocker in the machining line and/or the machining devices located behind the workpiece stocker to change the machining speeds thereof if the stock number determination unit determines that the change of the machining speeds is necessary.

2. The operation monitoring device according to claim 1, wherein the information on the state of the workpiece stocker includes information on workpiece loading from the workpiece stocker located before the machining devices in the machining line and information on workpiece unloading into the workpiece stocker located behind the machining devices in the machining line.

3. The operation monitoring device according to claim 1, wherein the information on the state of the workpiece stocker includes information detected by a sensor installed on the workpiece stocker.

4. The operation monitoring device according to claim 1, wherein the workpiece stocker management information storage unit further stores an upper-limit stock number and a lower-limit stock number, and the stock number determination unit is configured to determine that the change of the machining speeds is necessary for the machining devices located before the workpiece stocker in the machining line and/or the machining devices located behind the workpiece stocker if the workpiece stocker management information storage unit is stored with a workpiece stocker with the current stock number more than the upper-limit stock number or less than the lower-limit stock number.

5. The operation monitoring device according to claim 1, wherein the workpiece stocker management information storage unit further stores a rate of change, an upper-limit change rate, and a lower-limit change rate of the stock number for each workpiece stocker, and the stock number determination unit is configured to determine that the change of the machining speeds is necessary for the machining devices located before the workpiece stocker in the machining line and/or the machining devices located behind the workpiece stocker if the workpiece stocker management information storage unit is stored with a workpiece stocker with the stock number change rate higher than the upper-limit change rate or lower than the lower-limit change rate.
